(19) United States
(12) Patent Application Publication
(10) Pub. No.: US 2005/0240532 A1
(43) Pub. Date: Oct. 27, 2005

(54) Optical disk recording and reproducing method and optical disk

(75) Inventors: Tamotsu Iida, Osaka (JP); Reiji Tamura, Osaka (JP); Osamu Ishizaki, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/110,759

(22) Filed: Apr. 21, 2005

(30) Foreign Application Priority Data
Apr. 22, 2004 (JP) 2004-126995

(51) Int. Cl. G06F 17/60; H04K 1/00; H04L 9/00

(52) U.S. Cl. 705/57

(57) ABSTRACT

An optical disk recording and reproducing method. In a system for reproducing unique information which specifies a medium vendor and prohibits use by a third party in a control information area of an optical disk, this method reproduces the control information during a start-up period for recording or reproduction after the optical disk is loaded into a drive unit and displays the unique information on a display unit which is connected to the drive unit.

### CROSS-REFERENCE TO RELATED APPLICATION

The present invention is related to Japanese Patent Application Serial No. 2004-126995, which is hereby incorporated.

### BACKGROUND OF THE INVENTION

1. Field of the Invention

The present invention relates to a method of recording and reproducing an optical disk and, more particularly, to a technique of reproducing unique information recorded in a control information area containing control information required for driving an optical recording medium.

2. Description of Related Art

An optical disk has been used in an optical disk device that mainly records and reproduces information. Recently, a complex system provided with a function of displaying the information recorded in the optical disk is under development. The complex system involves a movie camera, for example. The movie camera reproduces and displays image information on a display composed of liquid crystal or organic electroluminescence, for example. This allows a user to check the shot images easily.

The optical disk has a user information area for recording images and a control information area for recording control information about the optical disk. The control information area is also called a read-in area or a control track area. The format of information track formed in the control information area and the user information area of the optical disk varies by the type of optical disk. Though there are a variety of types of optical disks, such as recordable and rewritable CD-R and CD-RW, higher density recordable and rewritable DVD-R, DVD-RW, and DVD-RAM, and still higher density BD disk and HD-DVD, each type has a control information area.

These optical disks are common in that information required for a drive unit to drive the optical disk is recorded as control information of the optical disk, though the format of information track is different. The information required for a drive unit to drive the optical disk includes initial condition information for recording and reproduction, vendor information of an optical disk, which is referred to simply as medium vendor information, production control information, format version information, and security information.

The control information recorded in the optical disk provides necessary information to a drive unit, not to a user. Thus, the control information is normally provided for the drive unit in order that the drive unit can drive the optical disk without failure. The user of the optical disk is interested merely in the combination of the medium vender and the drive vender.

The drive vender normally assures the recording by the drive unit by specifying the suggested medium vendor. Therefore, in order to see the combination of the medium vender and the drive vender in detail, a user may read the control information in the optical disk using analysis software and acquire medium vendor information. With use of the analysis software, the user can acquire medium vendor information to recognize that it is an original-equipment-manufacturer (OEM) product under different brand names.

As described above, the medium vendor information can be easily acquired from outside. However, since the drive unit makes various settings according to the medium vendor information, false recognition of the medium vendor information can not only cause the drive unit to operate improperly but also cause it to be inoperable. In this regard, the medium vendor information is very important.

Since the medium vendor information as one of control information can be acquired easily despite that it is important information for setting the configuration of the drive unit, confusion has occurred due to a malicious third party who makes medium vendor information that indicates a different party to be a vendor included into the control information in an optical disk which it provides. Presently, the drive unit sets detailed drive conditions that are not recorded in the control information, trusting the medium vendor information as the control information. Thus, the malicious third party would make an illegal copy of valid medium vendor information and records it in the optical disk in order to allow the optical disk which it provides to he accepted by the drive unit.

The medium vendor information as control information serves also as an indicator showing that it is manufactured by the medium vendor.

If the illegal copy of the medium vendor information is allowed, various problems would occur. First, it inhibits appropriate settings of the drive unit to impede user's effective use. Further, when failure occurs in the drive unit, a claim for the failure is delivered to a medium vendor specified by the illegally copied medium vendor information, which can bring discredit to the medium vendor which has nothing to do with the optical disk where the failure has occurred.

The effects of the illegal copy of the medium vendor information not only causes disadvantages to a user of the medium but also poses a risk of inflicting serious tangible and intangible damages to a legal medium vendor and drive vendor.

The controversial medium vendor information is normally recorded in codes. Specifically, ASCII code is used for the medium vendor information to identify a medium vendor with about 3 to 8 characters.

Though code data which is meaningful as control information is set to the medium vendor information, no means to restrict the use of code data corresponding to a medium vendor different from an actual medium vendor exists conventionally. Further, if the number of characters indicating code data is small, it is difficult to control copy by copyright or the like and receive legislative remedy. However, offering information about a medium to a user at least when the user is about to use the medium would allow the user to make a decision.

Therefore, means to offer the information that allows a user to make a decision to those who use an optical disk are required in an environment where various optical disks, applications and medium vendors exist.

A method of offering control information in a conventional optical disk is disclosed in Japanese Unexamined Patent Application Publication No. 8-31009 and 7-130134, for example. This method makes a unique information pattern visible to the naked eye emerge on an optical disk so that a user can recognize it. Though the area where the unique information pattern is created is not particularly set as a control information area, this technique allows a user to check a medium vendor.

However, since the pattern indicating unique information is visual information provided only in a medium in the above technique, it allows only identification by a user, not identification using a recording and reproducing device. The conventional method thus has a problem of recording and reproducing data even if it is an illegal configuration that is not consistent with control information.

Further, since medium vendor information in the conventional technique is presented using about 3 to 8 characters of ASCII code and is thus acquired easily, the information can be stolen easily. Furthermore, since the information amount of the medium vendor information is small and it is not direct information for identifying a medium vendor, it is necessary for a user to have knowledge about information on medium vendors supplying a medium to the market, codes used by medium vendors and so on in order to acquire medium vendor information and identify a medium vendor. It is therefore difficult for a user to recognize an illegal disk. In addition, though the use of a visible unique pattern allows a user to identify a manufacturer of a medium by visual observation, a drive unit does not recognize the unique pattern and thus operates normally even if the visible unique pattern is different from the vendor information of a medium identified by the drive, failing to eliminate the illegal disk.

### SUMMARY OF THE INVENTION

In view of the foregoing, an object of the present invention is to provide an optical disk drive system having means for offering media vendor information to a user of an optical disk and capable of identifying an illegal disk in a recording an reproducing device as well. Another object of the present invention is to provide an optical disk including control information suitable for offering the information.

Thus, an object of the present invention is to provide a system in which medium vendor information is visible to a user and also readable and identifiable to a drive device so as to eliminate an illegal medium based on the matching.

The present invention also describes a method of displaying control information for a product with a complex system combining a drive unit of an optical disk and a display unit, such as liquid crystal, for displaying information on recording and reproduction of the optical disk, such as a movie camera, to allow a user to check the images taken.

Since the optical disk drive unit and the display unit are integral, an environment for displaying or presenting the control information recorded in the optical disk is fixed. Thus, it is possible to display control information on the display unit by regulating an optical disk medium in which control information adjusted for display is recorded in a control information area and a process in a drive unit for displaying the control information.

If medium control information is displayed during recording and reproducing user data in an optical disk, it may disturb a user. However, since user data is not recorded or reproduced during a period when the optical disk medium is loaded into the drive unit, it would be acceptable to display the control information on the display unit in this time period. Further, when displaying the user information recorded in the optical disk medium in the file control unit, it is effective to display the information recorded in a medium control information area upon switching of images with different reproduction titles.

As described in the foregoing, the present invention aims at providing means for allowing unique control information of an optical disk medium to be displayed visible to a user by a drive unit of the optical display medium.

To these ends, according to one aspect of the present invention, there is provided an optical disk recording and reproducing method which includes recording unique information specifying a medium vendor and/or information supply vendor and prohibiting use by a third party onto a control information area of an optical disk; reading the unique information recorded in the control information area by a drive unit driving the optical disk; and displaying the unique information by a display unit connected to the drive unit.

The unique information is preferably displayed during a start-up period for recording or reproduction after the optical disk is loaded into the drive unit. The unique information may be displayed during a medium initialization time when the optical disk is loaded into the drive unit.

The unique information is preferably recorded in the control information area as image information. The unique information is a trademark in a preferred embodiment

According to another aspect of the present invention, there is provided an optical disk where unique information specifying a medium vendor and/or information supply vendor and prohibiting use by a third party is recorded in a control information area, wherein the unique information is displayed by a display unit connected to a drive unit driving the optical disk.

The unique information is preferably displayed during a start-up period for recording or reproduction after the optical disk is loaded into the drive unit. The unique information may be displayed during a medium initialization time when the optical disk is loaded into the drive unit.

The unique information is preferably recorded in the control information area as image information. The unique information is a trademark in a preferred embodiment. Information about recording and reproduction of information onto the optical disk may be generated or restored by using all or part of the unique information. Further, when recording or reproducing information onto the optical disk, recording or reproduction of the information may be set valid or invalid by using all or part of the unique information.

The optical disk of the present invention records unique information specifying a medium vendor and prohibiting use by a third party as control information. The unique information is image information, for example, which corresponds to a specific company or group or a specific product or product group and its feature can be identified by visual observation. Such images include a copyrighted image or a registered trademark.

It indicates that the image information cannot be used by a third party without a permit. The use of such an image needs right of exclusive license and displaying this image clearly defines the quality certification of an optical disk medium and the responsibilities of a manufacturer. By recording the image information restricting the use by a third party in the control information area and displaying it on the display unit connected to the drive unit, if a third party copies this image information and records it into a control information area of an optical disk supplied by another medium vendor, it is possible to prohibit the act of copying as fraud and thereby pursue the responsibility more promptly.

If the rules for recording specific image information to be recorded in a control information area onto a predetermined control information area on an optical disk are defined as specification, a drive unit according to the specification can treat the image information as the control information recorded in a predetermined area. It is thus easy to display the image information as the control information on a display unit even when a medium vendor and a drive vendor are different. This allows a user of an optical disk to display the control information recorded in the optical disk in a combination of a drive unit and the optical disk.

Besides the medium vendor, an information supply vendor which records information onto an optical disk and supplies it to a user exists. The recorded information is treated as contents information and composed in combination with movie, music, textual information, and image information. This system may be used for copyright notice of these contents. By showing an information supply vendor and displaying a trademark or character information indicating copyright before or after displaying a contents program, it is possible to allow a user to recognize it visually. It is feasible to display both unique information indicating a information supply vendor and unique information indicating a medium vendor at the same time.

The unique information specifying a medium vendor and prohibiting use by a third party as control information of an optical disk may be displayed while loading the optical disk into a drive unit. This is because the control information is the information to be read out first from a medium when the drive unit starts driving the optical disk. The information existing in a user area is read out after the drive unit completes setting with control information. The unique information specifying a medium vendor and prohibiting use by a third party which is recorded as the control information to be read out first is the data to be read out before then and thus can be displayed during the loading operation including initialization of the optical disk. Therefore, a user can check the image data being the unique information of the optical disk at this time. Normally, a system stops during the loading period of the optical disk and a user needs to wait during the initial setting phase. Displaying the control information in this waiting time allows clearly defining the quality certification of the optical disk medium and the responsibilities of a manufacturer.

In order to manufacture the optical recording medium of this invention, it is necessary to set an area for recording unique information and describe the unique information specifying a medium vendor and prohibiting use by a third party therein. The optical disk medium manufactured in this way allows reproducing the information stored in the control information area during a start-up period for recording or reproduction after the optical disk is loaded into a drive unit and displaying the information on a display unit connected to the drive unit.

The present invention allows appealing the reliability and credibility of an optical disk to a user. It prevents an optical disk in which third party's control information is illegally copied from going into circulation and allows a user to identify a high-quality recording medium, thereby enabling highly reliable system operation.

Further, since the present invention allows unique information to appear on a display unit, it is possible to configure a system protected by copyright or the like.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic plan view of an optical disk of the present invention;

FIG. 2 is a view to describe an optical disk drive unit of the present invention;

FIG. 3 is a view to describe the sequence of displaying image data being control information in a period from loading of an optical disk to a drive unit to start of recording and reproducing data in a user area;

FIG. 4 is a view to describe an example of the present invention; and

FIG. 5 is a view to describe a control information recording unit of the present invention.

### DESCRIPTION OF THE PREFERRED EMBODIMENTS

A drive system of an optical recording medium according to the present invention is described below with reference to embodiments. The present invention, however, is not limited thereto.

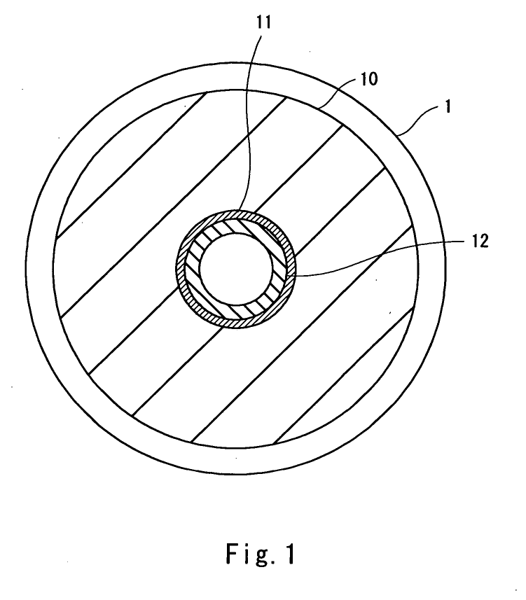

Referring first to FIG. 1, a preferred embodiment of the present invention is described hereinafter. An optical disk 1 includes a user information area 10 for recording user information and a control information area 12 for recording control information about the recording of the user information. A third area 11, which is normally not used for recording, may be placed between the user information area 10 and the control information area 12. The third area 11 may be mirror-finished or provided with grooves or pit lines. The third area 11 serves as a buffer to assimilate the different format configurations of the user information area 10 and the control information area 12. Though the control information area 12 is located in the inner side of the user information area 10 in the example of FIG. 1, it is not limited thereto. The control information area 12 may be located in the outer side of the user information area 10 or it may be located in both inner and outer sides of the user information area 10. Regardless of the location, the control information area 12 is reproduced prior to the user information area 10 when driving an optical disk.

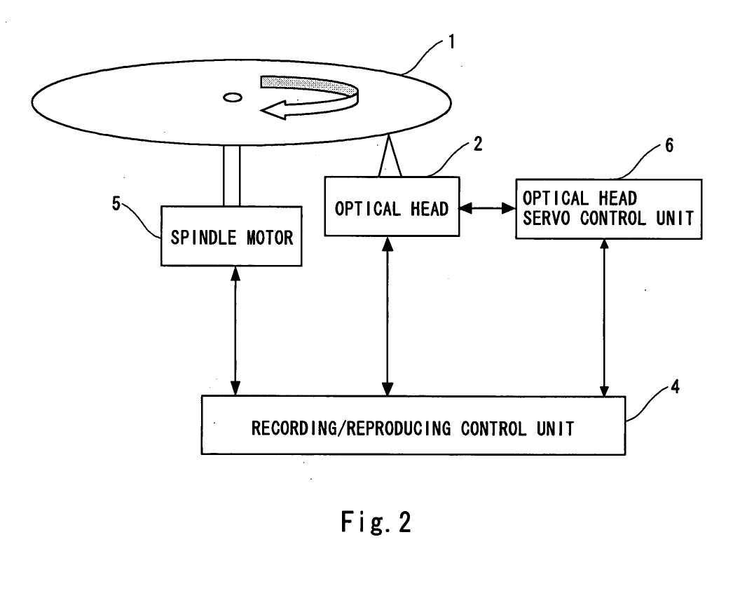

FIG. 2 is a view to describe the configuration of a drive unit. The optical disk 1 is rotationally driven by a spindle motor 5. An optical head 2 reproduces the control information of the optical disk 1. The optical head 2 is controlled by an optical head servo control unit 6 for tracking and focus servo on the data recording surface of the optical disk 1. The optical head 2 detects a reproduction signal from the optical disk 1 and outputs the signal to a recording/reproducing control unit 4. The recording/reproducing control unit 4 receives the reproduction signal from the optical head 2 and performs information processing required for recording and reproduction and provides instructions to the spindle motor 5 and the optical head servo control unit 6.

Referring next to FIG. 2, the reproducing processing of the optical disk 1 is described below. Before the drive unit starts driving the optical disk 1, the recording/reproducing control unit 4 rotates the spindle motor 5 so as to obtain the linear velocity required for reproduction. When the spindle motor 5 reaches a prescribed linear velocity, the optical head servo control unit 6 activates focus servo on the optical head 2 so that laser light is focused on the recording surface of the optical disk 1. Then, the optical head servo control unit 6 activates tracking servo on the optical head 2 so as to make tracking on the recording tracks of the optical disk 1. After that, the optical head 2 is moved to the control information area 12 to reproduce control information.

It is also feasible to move the optical head 2 to the control information area 12 once after performing the focus servo and then activate the tracking servo.

After reproducing the control information, a drive unit is set with information necessary for driving the optical disk 1. For example, a reproducing laser light output value, a recording laser light output value, a format version, data for specific medium manufacturer and so on are set.

In this embodiment, the control information contains unique information which specifies a medium vendor and prohibits use by a third party. The unique information is stored in image data format which displays an image on a display unit. The image data may be displayed in the period when the drive unit initializes the optical disk. The image data includes both still image data and video data. The unique information may be composed of voice data. In this case, the unique information in voice data format may be audio output by audio output means such as a speaker.

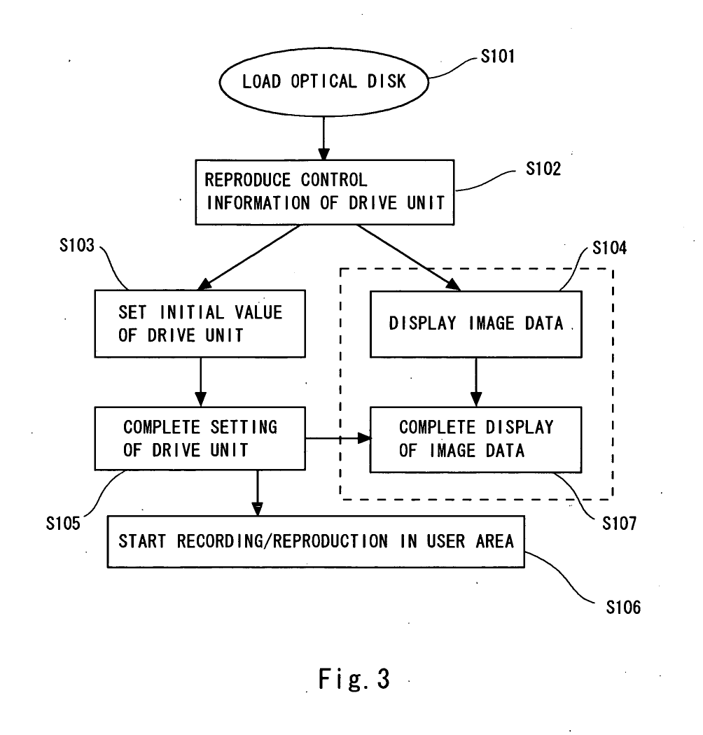

FIG. 3 shows the process from when an optical disk is loaded into an optical disk drive unit to when the recording and reproducing operation of a user area is ready to start.

When an optical disk is loaded into an drive unit (S101), the drive unit first reproduces the control information recorded in a control information area of the optical disk (S102). In this embodiment, the control information contains unique information in image data format. The reproduced control information is used for setting initial values in the drive unit (S103); at the same time, the unique information in image data format recorded in the control information area is displayed (S104). When the setting of the drive unit ends (S105), recording and reproducing operation of the user area becomes ready to start (S106). Upon reaching this state, the display of the unique information in image data format stored in the control information area ends (S107).

Similarly, when the initialization of the optical desk is performed, the unique information in image data format recorded in the control information area may be displayed in the initialization period. Initial use of an optical disk normally requires format processing, and the period of the format processing corresponds to the period of the initialization.

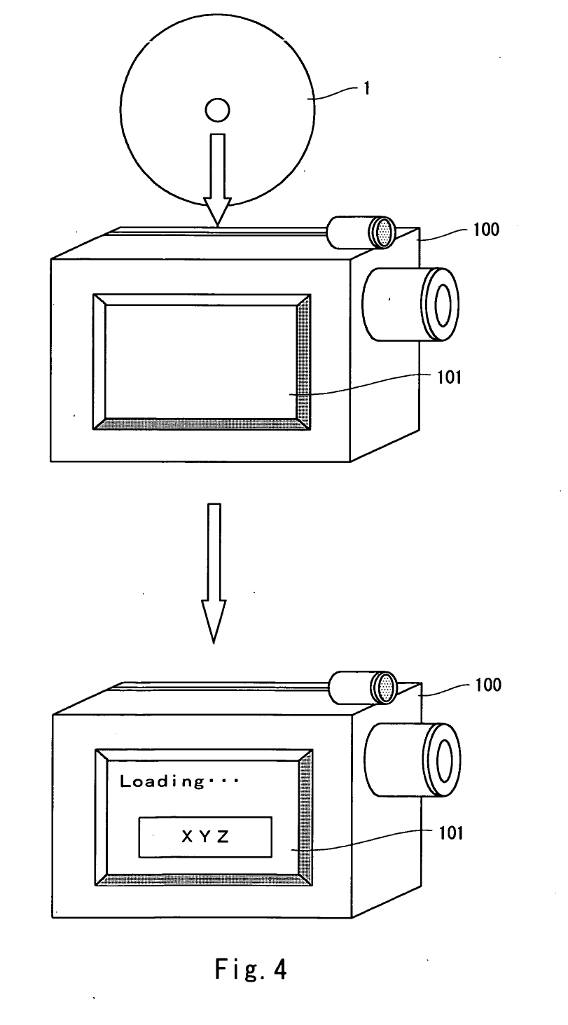

FIG. 4 shows the conditions of the process described with reference to FIG. 3. Firstly, the optical disk 1 is loaded into an optical disk recordable video camera 100 that integrates an optical disk drive unit and a display unit 101 together. The vide camera 100 does not enter the shooting mode until an initialization process by the optical disk drive unit ends after the loading of the optical disk 1. Thus, a user needs to wait during the initialization process. During this waiting time, part of control information can be displayed on the display unit 101 as shown in FIG. 4. In this example, the image data “XYZ” is displayed. The image data “XYZ” in this example indicates unique information which identifies a medium vendor and prohibits use by a third party. For example, the image data “XYZ” may be a trademark of a medium vendor. The image data “XYZ” is kept displayed until the initialization process in the optical disk drive ends and it shifts to the shootable state. Though the image data is a trademark in this example, it may be the title of information, the logo of a standard, the name of an owner, the name or logo of a standard organization, and so on. The unique information recorded in the optical disk may be displayed continuously during reproduction of the optical disk or displayed in response to a request by a user.

The process of forming an optical disk according to an embodiment of the invention is described hereafter.

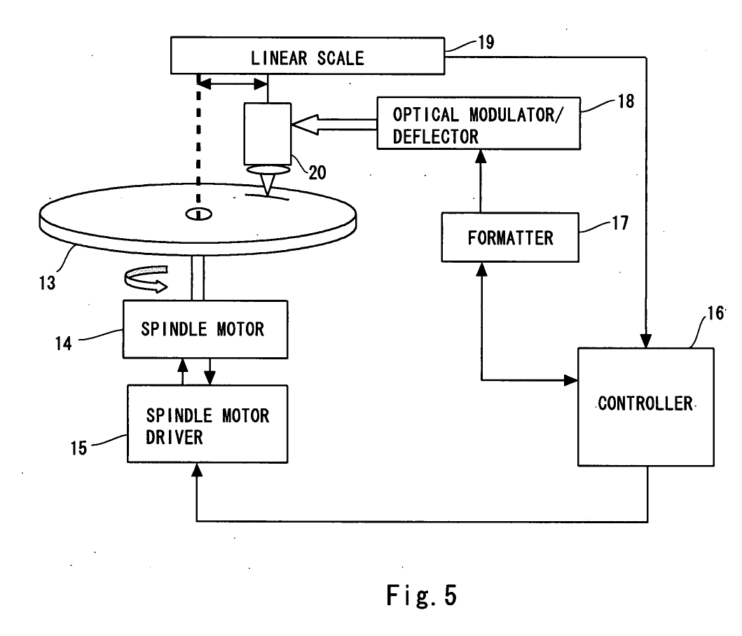

FIG. 5 is a diagram illustrating the configuration of a master device for recording information such as control information onto an optical disk master. The mastering that records information onto an optical disk master is described with reference to the block diagram of FIG. 5. When forming an optical disk, a stamper as a mold is created from an optical disk master on which a desired preformat pattern is cut, and the stamper is used to make a replica disk by injection molding. The cutting on the optical disk master is made by an optical disk master exposing device, which is a master device.

The master device of FIG. 5 includes an optical disk master 13, a spindle motor 14 that rotationally drives the optical disk master 13, a spindle motor driver 15 that drives and controls the spindle motor 14, and a controller 16. The master device also includes a formatter 17, an optical modulator/deflector 18 that signal-modulates an optical beam output from an optical head, a linear scale 19 that measures the position of an optical head with respect to the optical disk master 13 and outputs a measurement result to the controller 16, and an optical head 20 that emits an optical beam.

The master device records control information in a predetermined control information area. Specifically, the master device specifies the recording position by the optical disk master 13 placed on an accurate rotary table connected to the spindle motor 14 and the optical head 20 and records information therein. Then, the optical modulator 18 signal-modulates the optical beam output from the optical head 20 in accordance with the format information generated by the formatter 17. The format information includes information for recording control information containing unique information onto a predetermined control information area. The control information containing unique information is thereby recorded in the control information area of the optical disk master 13.

The information recorded by the master device is inherited into a mold that is used as a stamper for mass-production. Therefore, the information recorded by the master device is controlled in distinction from the user information recorded in the user information area.

Though the above example stores unique information which specifies a medium vendor and prohibits use by a third party as image data into the control information area of the optical disk, it is feasible to store additional information to enhance security. For example, unique information which specifies the owner of data recorded in a recording medium and history information determined according to the recording of data onto the recording medium may be pre-recorded in the control information area of the optical disk during the production process of the recording medium. Further, operational control information that is operated using The unique information and the history information may be recorded in part of the control information, which is information about drive conditions of the drive unit of the optical disk, such as recording/reproducing/erasing conditions of the disk, stored in an area different from the area storing the unique information and the history information within the control information area of the optical disk. The drive unit may decode the operational control information using the unique information and the history information and drive the optical disk upon acquiring normal control information. If the drive unit fails to decode the control information normally, it stops driving the optical disk.

In this way, the control information is controlled by the unique information and the history information recorded in a different area from the control information. Thus, even if the control information recorded in the optical disk is copied and used as it is, it is impossible to reproduce the control information when the contents of the information change. Since unique information is used for the operation of the control information required for accurate driving of a recording medium, it is necessary to copy the unique information together with the control information, which facilitates to specify copying by a third party. Further, since the contents of the history information changeover time and the operated control information also changes in the converted information, it is possible to prevent copying by a third party. As described above, this method operates the control information and records the operated control information and the information required for decoding the control information onto the recording medium, thereby ensuring the reliability of a high-density optical disk such as an optical disk and the security of recorded information.

Information about recording or reproduction of the information in the optical disk may be generated or restored by using all or part of the unique information. Further, when recording or reproducing information in the optical disk, recording or reproduction of the information may be set valid or invalid by using all or part of the unique information.

Specifically, when recording control information in a predetermined control information area, a master device uses all or part of unique information to perform a logic operation such as exclusive-OR on the control information at least including the unique information. The unique information and the control information after the logic operation are thereby stored in the control information area. A logic operation algorithm may be various algorithms known in the data processing field. The information recorded by the master device is inherited into a mold that is used as a stamper for mass-production and recorded on an optical disk.

When reproducing the control information after logic operation stored in the control information area of the optical disk, the drive unit performs a logic operation with an algorithm corresponding to a logic operation algorithm in recording. The logic operation in reproduction also uses all or part of the unique information stored in the optical disk together with the control information after logic operation. For example, a logic operation such as exclusive-OR is performed on the control information after logic operation using all or part of the unique information.

Since the control information thus obtained contains unique information, the drive unit compares this unique information with the unique information stored in the optical disk as it is. If the comparison shows that they match, the drive unit determines reproduction to be valid and carries out reproduction. If, on the contrary, the comparison shows that they do not match, the drive unit determines reproduction to be invalid and does not carry out reproduction.

The verification operation may be performed also when storing new information into a user information area. Specifically, the drive unit performs a logic operation such as exclusive-OR on control information after logic operation using all or part of unique information. The drive unit compares the unique information obtained by this operation with the unique information stored in the optical disk as it is. If the comparison shows that they match, the drive unit determines recording to be valid and carries out recording of information into the user information area. If, on the contrary, the comparison shows that they do not match, the drive unit determines recording to be invalid and does not carry out recording of information into the user information area. By using the unique information for the verification, it is possible to allow only the drive unit capable of performing a predetermined logic operation to acquire the control information of the optical disk and carry out reproduction or recording. Thus, reproduction or recording can be carried out only in a combination of the optical disk which is not a copy and the drive unit, thereby eliminating a copy.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. An optical disk recording and reproducing method comprising:
recording unique information specifying a medium vendor and/or information supply vendor and prohibiting use by a third party onto a control information area of an optical disk;
reading the unique information recorded in the control information area by a drive unit driving the optical disk; and
displaying the unique information by a display unit connected to the drive unit.

2. The optical disk recording and reproducing method of claim 1, wherein the unique information is displayed during a start-up period for recording or reproduction after the optical disk is loaded into the drive unit.

3. The optical disk recording and reproducing method of claim 1, wherein the unique information is displayed during a medium initialization time when the optical disk is loaded into the drive unit.

4. The optical disk recording and reproducing method of claim 1, wherein the unique information is recorded in the control information area as image information.

5. The optical disk recording and reproducing method of claim 1, wherein the unique information is a trademark.

6. The optical disk recording and reproducing method of claim 1, wherein information about recording or reproduction of information onto the optical disk is generated or restored by using all or part of the unique information.

7. The optical disk recording and reproducing method of claim 1, wherein, when recording or reproducing information onto the optical disk, recording or reproduction of the information is set valid or invalid by using all or part of the unique information.

8. An optical disk where unique information specifying a medium vendor and/or information supply vendor and prohibiting use by a third party is recorded in a control information area, wherein the unique information is displayed by a display unit connected to a drive unit driving the optical disk.

9. The optical disk of claim 6, wherein the unique information is reproduced and displayed during a start-up period for recording or reproduction after the optical disk is loaded into the drive unit.

10. The optical disk of claim 6, wherein the unique information is reproduced and displayed during a medium initialization time when the optical disk is loaded into the drive unit.

11. The optical disk of claim 6, wherein the unique information is recorded in the control information area as image information.

12. The optical disk of claim 6, wherein the unique information is a trademark.
